(19) United States
(12) Patent Application Publication
(10) Pub. No.: US 2007/0100664 A1
(43) Pub. Date: May 3, 2007

(54) INTEGRATED HEALTHCARE AND FINANCIAL CARD

(76) Inventors: Christopher D. Seib, Costa Mesa, CA (US); Brian R. Bentow, Bell Canyon, CA (US); William F. Marvin, Philadelphia, PA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/556,551

(22) Filed: Nov. 3, 2006

Related U.S. Application Data
(60) Provisional application No. 60/734,363, filed on Nov. 3, 2005.

(51) Int. Cl. G06Q 10/00; G06Q 40/00

(52) U.S. Cl. 705/2; 705/4; 705/41

(57) ABSTRACT

A magnetic swipe card for storing and transmitting data is described herein. The magnetic swipe card includes a magnetic stripe having at least two tracks holding encoded data. A first track at least includes data for at least one first party payment source. A second track at least includes data for healthcare eligibility information for at least one card holder, and or at least one unique identifier or a format identifier referencing healthcare eligibility information.

### CROSS-REFERENCE TO RELATED APPLICATIONS

This application claims the priority benefit of U.S. Provisional Patent Application No., 60/734,363, entitled “Integrated Healthcare and Financial Card”, filed on Nov. 3, 2005.

### BACKGROUND

The disclosure generally relates to devices and systems for use in healthcare and financial applications. More particularly, the disclosure relates to a device that includes a patient's information to facilitate a healthcare eligibility/benefit inquiry and payment transaction.

Many healthcare payer entities issue a card containing information identifying an insured party, such as, for example, a name and/or an identification number, and a group number, if applicable to members as proof of coverage. In some cases, such a card may additionally contain a means for embedding this information into the card or a means for electronically transferring information identifying the insured party such as, for example, by magnetic stripe and/or a programmable chip. A healthcare service provider wishing to verify a patient's eligibility and/or benefit information may use such a card to visually and/or electronically obtain information regarding the patient's coverage.

The healthcare identification cards issued to insured parties generally act as proof of coverage under a particular healthcare plan, and embedded information may be used to determine such as, for example, deductibles, plan coverages, and co-pays, may he used to determine the portion of the total owed for services rendered that is the patient's responsibility. The healthcare service provider may then bill the patient for this portion of the amount owed. However, there may be a waiting period before the healthcare service provider receives payment from the responsible party, and during this waiting period, the healthcare service provider may need to contact the responsible party multiple times to make continued requests for payment. This may be a very time consuming and inefficient process.

Financial entities are part of another industry that also uses cards containing embedded information identifying a party holding a financial account with the financial entity, such as, for example, a name and/or identification number, and an expiration date, and allows the identifying party to authorize a financial transaction from the account. In many cases, embedded information is provided electronically on a card using, for example, a magnetic stripe or a programmable chip, and the information may be transferred from a card holder to a receiving entity by, for example, swiping the magnetic stripe or placing the card in a card reading device.

Magnetic swipe card technology is an established and widely adopted technology available for initiating transactions from a card. For example, most credit and/or debit cards issued by banks or other lending companies contain magnetic stripes which may be swiped allowing the electronic transfer of information from a magnetic swipe card to a computer or magnetic stripe card reader. In most magnetic swipe cards, three tracks or slots are available for the storage of data in the magnetic stripe. According to the International Standards Organization and International Electrotechnical Commission (ISO/EC) standard 7811, track one is, generally, 210 bits per inch (bpi) and holds 79 six-bit plus parity bit read-only characters, track two is 75 bpi and holds 40 four-bit plus parity bit characters, and track three is 210 bpi and holds 107 four-bit plus parity bit characters. However in general, credit and debit cards use only tracks one and two, and the use of track three is not standardized.

To improve the process by which a healthcare service provider obtains payment from the patient, a healthcare service provider may wish to obtain a patient's eligibility and benefit information, as well as financial information regarding one or more accounts which may be used to collect funds from the patient. Accordingly, it may be beneficial to provide a single card containing data specific to both healthcare coverage and Financial transactions, and in particular, information sufficient to launch a healthcare eligibility and benefit inquiry and a financial transaction, The card or device may contain information sufficient to launch a patient healthcare eligibility and benefits inquiry and initiate a financial transaction. This reduces time and costs involved in the current process and provides value and convenience to the healthcare service provider as well as to the subscriber or responsible party.

### SUMMARY

An embodiment is directed to a magnetic swipe card for storing and transmitting data. The magnetic swipe card includes a magnetic stripe having at least two tracks holding encoded data. A first track at least includes data for at least one first party payment source. A second track at least includes data for healthcare eligibility information for at least one card holder. The healthcare eligibility information further includes at least one unique identifier or format code identifier where the unique identifier is different from an identifier on the first track.

The at least one unique identifier may be assigned by a service provider and may be a combination of characters unique to an individual holding the magnetic swipe card. The at least one format code identifier may be assigned by a service provider and may refer to a field in a database, table or reference sheet maintained by the service provider. In another embodiment, the unique identifier or format code identifier on the card, subscriber information on the card, patient information on the card, or a combination thereof may provide a healthcare service provider with access to personal and benefit and eligibility information held by the service provider sufficient to launch a HIPAA compliant eligibility inquiry.

The at least first party payer entity may be a savings account, a checking account, a debit account. a credit card account, an electronic benefit transfer account, and a prepaid account. The healthcare eligibility data on a second track may include at least one unique identifier, personal data for at least one card holder, data for at least one payer entity, at least one third party payment source for the at least one card holder, and combinations thereof. The at least one payer entity may be a healthcare payer entity or an insurance company; the third party payment source may be government assistance, social security, cafeteria plan, gift certificate, loyalty credit, and insurance settlement account.

The first track may at least include a field holding a first party payment account holder name or equivalent sub-fields and a field holding a first party payment account number or equivalent sub-fields. In some embodiments the magnetic swipe card may include two tracks that are ISO/IEC compliant and a third track with healthcare eligibility information.

In embodiments, a track may include fields including one or more subscriber ID. one or more subscriber ID qualifier, a subscriber date of birth, at least one payer entity ID, at least one payer entity qualifier, a subscriber name, a subscriber gender a card format version number, a patient name, a patient relationship to a subscriber, a patient gender, at least one patient ID, at least one patient qualifier, and combinations thereof or subsets thereof. These fields may be in any desired order.

Another embodiment is directed to a method for initiating a financial transaction using a magnetic swipe card including providing a magnetic swipe card. The method includes providing a magnetic swipe card, scanning the magnetic swipe card, and performing a financial transaction or performing a healthcare benefit and eligibility transaction or combination thereof.

The magnetic swipe card includes a magnetic stripe having at least two tracks holding encoded data. A first track at least includes data for at least one first party payment source. A second track at least includes data for healthcare eligibility information for at least one card holder. The healthcare eligibility information further includes at least one unique identifier or format code identifier. The least one unique identifier or format code identifier is different from an identifier on the first track. In some embodiments, performing a healthcare benefit and eligibility transaction may include determining benefit eligibility for an individual from information provided on the card, compiling benefit eligibility information, payment source information, and cost of services provided information, estimating an amount for which the individual is responsible, submitting one or more claim to the at least once payer entity, and deducting the amount for which the individual is responsible from the at least one first party payment source.

The magnetic swipe card includes a magnetic stripe having at least two tracks holding encoded data wherein a first track at least includes data for at least one first party payment source and a second track at least includes data for healthcare eligibility information for at least one card holder. The healthcare eligibility information further includes at least one unique identifier, wherein the at least one unique identifier is different from an identifier on the first track. The healthcare eligibility information for at least one card holder may further include personal data for at least one card holder, data for at least one payer entity, data for one or more third party payment source, and combinations thereof in some embodiments.

The method may further include retrieving information selected from personal data for at least one card holder, eligibility and benefit data for the at least one card holder from at least one payer entity, at least one third party payment source for the at least one card holder, and combinations thereof from a service provider using the unique identifier or format code identifier on the card, subscriber information on the card, patient information on the card, or a combination thereof. The method may also include the step of deducting to occur automatically. The method may further include authorizing a deduction from the at least one first party payment entity for deducting the amount for which the individual is responsible, and in embodiments, the step of authorizing may occur automatically. Verifying benefit and eligibility information may occur automatically when the card is scanned.

In some embodiments, the steps of determining benefit eligibility, estimating the amount for which an individual is responsible, submitting a claim, and deducting the amount for which the individual is responsible may occur on a processor, and in others the steps of determining benefit eligibility, estimating the amount for which an individual is responsible, submitting a claim, and deducting the amount for which the individual is responsible are completed by a service provider.

Still other embodiments include a system for facilitating payment using a magnetic swipe card having a magnetic swipe card. The system further includes a point of sale (POS) terminal, which may have a physical screen and a keypad, or a virtual POS terminal where the m magnetic swipe card is scanned, a processor for receiving information from the magnetic swipe card and utilizing the information from the magnetic swipe card to determine benefit eligibility and an amount for which an individual is responsible, a means for retrieving data for determining benefit eligibility information, personal information for at least one card holder, first party payment source information, third party payment source information, payer entity information, and combinations thereof, a means for submitting a claim; and a means for deducting the amount for which the individual is responsible from at least one first party payment source. In embodiments, the means for retrieving data, submitting the claim, and deducting the amount for which the individual is responsible may be a service provider.

The magnetic swipe card includes a magnetic stripe having at least two tracks holding encoded data. A first track at least includes data for at least one first party payment source and a second track at least includes data for healthcare eligibility information for at least one card holder. The healthcare eligibility information further includes at least one unique identifier where the unique identifier is different from an identifier on the first track.

### BRIEF DESCRIPTION OF THE DRAWINGS

For a fuller understanding of the nature and advantages of the present invention, reference should be made to the following detailed description taken in connection with the accompanying drawing, in which:

FIG. 1 illustrates tracks on a magnetic swipe card according to an embodiment of the invention.

FIG. 2 illustrates tracks on a magnetic strip card according to another embodiment of the invention.

FIG. 3 illustrates a flow chart of an embodiment of the invention.

### DETAILED DESCRIPTION

Before the present device methods, systems and materials are described, it is to be understood that this disclosure is not limited to the particular methodologies, systems and materials described, as these m ay vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Unless defined otherwise, all technical and scientific terms used herein have the same meanings as commonly understood by one of ordinary skill in the art, Although any methods, materials, systems and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention.

A “healthcare service provider” or “provider” as used herein may refer to any entity that provides healthcare services to a patient or individual, such as, but not limited to, a physician, nurse, dentist, pharmacist, or hospital.

A “healthcare payer entity” as used herein may be any entity which provides payment for services rendered by a healthcare service provider, such as, for example, an insurance company. The term “healthcare benefit entity” may be used interchangeably with “healthcare payer entity” and may refer to payment rendered for healthcare services as “benefits”. A primary enrollee or subscriber to a plan issued by a healthcare payer entity may, therefore, be referred to as a “benefit subscriber” having “healthcare benefits”, and these benefits may cover themselves as well as any number of dependents.

A “financial account holder” may refer to one or more individual leaving access to funds available within a financial account.

A “financial entity” may refer to any entity holding financial account for one or more responsible party or individual, such as, but not limited to, a bank, a credit union, a credit card company, and a lending company.

A “financial service provider” may be any entity through which a responsible party or individual may obtain payment for services rendered such as, but not limited to, an insurance company, a bank, and a credit card company.

A “service provider” as used herein may be any entity that acts as a repository for healthcare information. In some embodiments, a service provider may act as an agent that routes information to and from a healthcare service provider, a payer entity, a financial service provider, and the like, and in other embodiments, the service provider may be a third party separate from either a healthcare service provider, a payer entity, or a subscriber that holds or may control healthcare information for a card holder.

“Healthcare eligibility information” as used herein may include a unique identifier personal information regarding a subscriber and a payer entity, or information regarding the compensation available to particular healthcare service provider for specific services provided to a particular subscriber.

A “unique identifier” as used herein may be an alphanumeric code which may provide a healthcare service provider, or other entity with specific information regarding a cardholder or patient, for example, the cardholder or patient's name, birth date, or social security number. The information provided may, generally, be stored by a third party, and the heath-care service provider may be required to utilize a third party service provider to obtain the information.

A “format code identifier” as used herein may refer to a code that references specific data fields within a database, table, or reference sheet. For example, a format code identifier may refer a healthcare service provider to a field having a subscriber ID and Subscriber date of birth. The healthcare service provider may not have access to fields other than those referred to by the format code identifier. In embodiments, the database, table, or reference sheet may be held by a third party service provider and the data may be transferred by providing the format code identifier to a track parser that retrieves the necessary data.

The Health Insurance Portability and Accountability Act of 1996 (hereinafter “HIPPA”), as amended to date, defines guidelines for privacy security, and interoperability in the healthcare industry in the United States, and a “HIPAA Compliant Eligibility and Benefit Inquiry Transaction” may refer to any inquiry that complies with the standards and guidelines set forth by HIPAA,

The disclosure generally relates to a device or card having encoded data pertaining to eligibility and benefit information and financial account information for an individual identified by the card, and methods of using the card. The encoded data provided on the card may be sufficient to launch an eligibility and benefit inquiry in a healthcare payer entity and a financial transaction. The card may also be used to determine a portion of an amount owed that is the responsibility of the individual' In an embodiment, the card may be a magnetic swipe card having a magnetic stripe. Alternatively, the card may be a “smart card” having a programmable microchip.

In particular, devices or cards of embodiments of the invention may be “smart cards” being either a memory card or a multi-function, microprocessor card, a card having a magnetic stripe, or a combination thereof. In a preferred embodiment where the card is a magnetic stripe or memory card without a microprocessor, processing as discussed herein below may take place at a point-of sale (POS) terminal or a computer processor attached to the POS. However, the information stored on the card may act as the hub (intersection, junction, nexus, node) for processing.

In embodiments, a magnetic swipe card may contain a magnetic storage device, for example a magnetic stripe, including at least three tracks or slots for the storage of data in the magnetic stripe and in some embodiments, a card may include six tracks. “Data” or “information” as referred to herein and as understood by one skilled in the art to indicate encoded data or encoded information and may be arranged on these tracks in any order.

In embodiments, a magnetic swipe card may be issued by a bank such as a credit or debit card. For example, a magnetic swipe card may have three tracks or slots available for storage of data in the magnetic stripe. According to the International Standards Organization and International Electrotechnical Commission (WO/IIEC) standard 7811, track one may, generally, be 210 bits per inch (bpi) and hold 79 six-bit plus parity bit read-only characters, track two may be 75 bpi and hold 40 four-bit plus parity bit characters, and track three may be 210 bpi and hold 107 four-bit plus parity bit characters. Credit and debit cards may use only tracks one and two, and track three may not be standardized. In embodiments, data on tracks one and two may be arranged to be compliant with ISO/IEC standard 7811. In some embodiments, track three may contain information necessary to perform a standard HIPAA transaction.

The information on track one is commonly contained in two formats: A, which is reserved for proprietary use of the card issuer, and B, which includes the following: start sentinel—one character, format code=“B” =—one character (alpha only), primary account number—up to 19 characters, separator—one character, country code—three characters, name—two to 26 characters, separator—one character, expiration date or separator four characters or one character, discretionary data—enough characters to fill out maximum record length (79 characters total), end sentinel—one character, longitudinal redundancy check (LRC)—one character, LRC is a form of computed check character.

The format for track two, developed by the banking industry, is as follows: start sentinel one character, primary account number—up to 19 characters, separator—one character, country code three characters, expiration date or separator four characters or one character, discretionary data—enough characters to fill out maximum record length (40 characters total), LRC—one character.

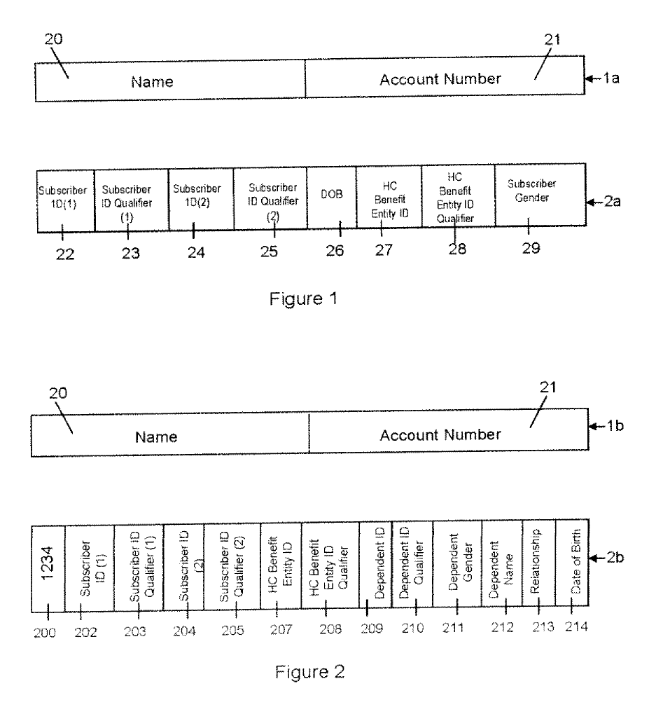

In embodiments, financial information on tracks one and two may or may not be for an account held by the card holder, for example, it may be for a dependent of the card holder. The format for track three may include healthcare information such as that described hereinbelow, for example, in FIGS. 1 and 2. Additionally, track three may include a unique identifier or format code identifier referencing healthcare information for the card holder.

A card of embodiments may be issued to a subscriber, patient, or dependent and may contain information generally, on an insurance card, such as, but not limited to, the subscriber's personal information, for example, name, address, phone number, social security number, and the like, and information regarding the subscriber's benefit information, for example, plan identification number, insurance company contact information or an electronic link to the insurance company, insurance eligibility information and status, such as, policy limits, co-pays, deductibles, fee schedules, and the like. The card may also include information that is not generally contained on an insurance card, such as for example, first party payment information, such as, the subscriber's desired method of payment for charges to the patient, for example, a credit or debit card, check. electronic benefits transfers (EBT) or prepayments, and the like, and third party payments, such as, but not limited to, insurance settlements, government assistance, social security, cafeteria plans, gift certificates, loyalty and private credit, and any other source of payment that is not the primary healthcare payer entity and is not a direct payment from the patient. In certain embodiments, the first party payment information includes information to initiate a financial transaction using the subscriber's preferred method of payment such as, for example, account numbers, expiration dates, electronic signatures, and the like.

In other embodiments, a single card may hold information concerning multiple entities that may be required to act as a result of services rendered to the card holder/subscriber such as, for example, a healthcare payer entity, a first party payment company, and third party payment company. For example, the card may hold or include information regarding a contract between the subscriber/card holder and an insurance company such as, an insurance plan, wherein the insurance company agrees to pay for a portion of services rendered by a healthcare service provider. The card may also hold information regarding a contract or agreement between the responsible party and a first party payment source such as, a credit, debit, checking or savings accounts, or one or more credit lines and, in sonic embodiments, a third party payment source such as, pension funds, government agencies, and the like. In certain embodiments, by using the card. the subscriber may agree to allow the healthcare service provider to bill a payer entity for an amount agreed to by the payer entity in a contract with the subscriber, and to deduct any amount not covered by the payer entity, a remaining balance after the payer entity has compensated the provider, from one or more identified first party payment source and/or third party payment source.

For example in embodiments, a card may include information specific to a credit card account, which may or may not have a pre-approved spending limit, held by the subscriber and this account may act as a first party payment account. Therefore, any charges not paid by a healthcare payer entity may be directly deducted from the credit card account. In other embodiments, the card may provide transaction information for several accounts, for example, a credit card account and a checking or savings account that may be selected from as the first party payment source. and the subscriber may choose between these accounts or deduct a specified amount from one or more such accounts. In still other embodiments, the accounts and the amount deducted from each account may be determined using a set of MSA's, FSA: Employer Flexible Spending Accounts, and the like.

In some embodiments, information on the card may be used to access specific information regarding, for example, the subscriber, patients insurance policy information, benefit structure, payer entity policies, fee schedules, to-date co-pay and deductible information, and the like. In other embodiments, access may also be provided to a service provider who may perform all or a part of the financial transactions, claim submission, or payment and claim amount determination. A “fee schedule” as used herein may be a contract concerning pricing of services between a healthcare service provider and an insurance company subscriber. Put another way, the insurance coverage of the patient may tell the healthcare service provider what to charge based on the contract that the healthcare service provider has made with the patient's insurance. Once accessed, the information can be used to determine an estimate of an amount owed by a responsible party for the services that have or may be rendered. In such embodiments, a provider may acquire access to a large store of information regarding the subscriber, one or more payer entity, and at least one financial account with a single swipe of the card.

In other embodiments, the healthcare service provider may access or exchange information stored on the card to contact a financial service provider to obtain information regarding a subscriber and/or any agreement between a subscriber and a financial service provider or payment on behalf of the patient. In still other embodiments, a healthcare service provider and one or more financial service provider may exchange information and payment using information contained on the card, and in certain embodiments, the exchange may occur with the assistance of a processor or service provider which may serve as an intermediary between, for example, a healthcare service provider, a financial service provider, a healthcare network, or a financial network. The service provider may be a single entity, having a relationship with each relevant party, or the service provider may include multiple processors having relationships with one or more relevant party. For example, one service provider, or processor, may act as a clearing house for transferring payment information between the first party payment source and a healthcare service provider, and a separate service provider, or processor, may act as a clearinghouse for transferring information between a healthcare service provider and an insurance company. In some embodiments, an indirect relationship may exist between, for example, the subscriber/card holder and the service provider wherein the subscriber is unaware of the service provider, and in others, a transaction may be accomplished directly between, for example, a healthcare service provider and a first party payment source with the use of a service provider.

In embodiments, information may be held on the card on a magnetic stripe having at least two tracks. For example, a first track and second track may hold information regarding a first party payment entity such as for example a name for a financial account holder or equivalent sub fields, a financial account number for an account held by an individual for whom services have been provided. A separate or third track may hold at least a unique identifier or a format code identifier, The unique identifier or format code identifier may be different from any identifier included on any other track provided on the magnetic stripe, and in embodiments, may not be accessible to any entity other than the healthcare service provider, healthcare payer entity, or service provider. For example, the unique identifier or format code identifier on the card, subscriber information on the card, patient information on the card, or a combination thereof identifier may allow a healthcare service provider to access information while preventing a financial entity from accessing the same information. In certain embodiments, the unique identifier or format code identifier may allow the healthcare service provider to access information regarding, for example, a subscriber or patient personal and benefit and eligibility information. This information may be held by a healthcare payer entity or a service provider and may be sufficient to launch a H.IPAA compliant eligibility inquiry or transaction. In further embodiments, the unique identifier or format code identifier may define a set of search criteria along with the required subscriber patient information to perform a HIPAA compliant eligibility inquiry. In still other embodiments, the separate track may further hold personal data for at least one card holder, eligibility and benefit data for the at least one card holder from at least one payer entity, at least one third party payment source for the at least one card holder, and combinations thereof.

Data within each track may be encoded in various fields or segments in ally desired order. For example, an initial segment of a track on the magnetic strip may include a start sentinel and the last track may contain a longitudinal redundancy check (LRC). Intermediate segments may include, for example, data relating to a financial institution that issued the card, an account number, subscriber personal information, payer entity data, first or third payment source data, and the like. For example, a first track may contain at least a field holding a name for an individual holding a financial account and a field containing a financial account number for the financial account, The first track may further contain for example, a start sentinel, a format code, a country code, one or more separators, an expiration date, a discretionary data field, an end sentinel, a longitudinal redundancy check (LRC), and the like and combinations thereof. A separate track may hold fields pertaining to benefit and eligibility information at least including a unique identifier or format code identifier for the subscriber. Additional fields on the separate track may include, but not be limited to, one or more subscriber ID, one or more subscriber ID qualifier, a subscriber name, a subscriber date of birth, a subscriber gender, one or more payer ID, one or more payer ID qualifier, one or more patient ID, one or more patient ID qualifier, a patient name, a patient date of birth, a patient relationship to a subscriber, a patient gender, a start sentinel, an end sentinel, one or more separator, a format code, and combinations thereof

Fields within tracks on a magnetic stripe may be in any order. For example, the fields on a tracks of a magnetic stripe may be arranged as illustrated in FIG. 1, a first track la may hold a name 20 and account number 21 for a subscriber, and a separate track 2a, may hold a first subscriber ID 22, a first subscriber ID qualifier 23, a second subscriber ID 24, a second subscriber ID qualifier 25, a subscriber date of birth 26, health care benefit entity ID 27, health care benefit entity ID qualifier 28, and subscriber gender 29 in the described order. Alternatively the separate track 2b may be arranged as illustrated in FIG. 2, a format code 200,. may be followed by a first subscriber ID 202, a first subscriber ID qualifier 203, a second subscriber ID 204, a second subscriber ID qualifier 205, health care benefit entity ID 207, health care benefit entity ID qualifier 208, a patient or dependent ID 209, a patient or dependent ID qualifier 210, a patient or dependent gender 211, a patient or dependent name 212, a relationship between the subscriber and the patient or dependent 213, and a patient or dependent date of birth 214. Additionally, a start sentinel and an end sentinel may be on either end of the track, a separator may be placed between individual fields, and the like. Fields may also be grouped such that information regarding a payer entity, a subscriber, or a patient may be grouped on a separate track.

In certain embodiments, the separate track may contain only a unique identifier, format code identifier or reference number assigned to an individual healthcare subscriber or patient by a payer entity or a service providers The healthcare service provider may use the unique identifier or format code identifier to access information regarding the patient or subscriber, such as, for example, benefit and eligibility information for the patient or subscriber, and in some embodiments, this information may be sufficient to launch a HIPAA eligibility inquiry. The card itself may therefore only contain an identifier, or reference number, and benefit information may be stored elsewhere, such as at a service provider, where it may be more secure. In embodiments, the information may be accessed using a network. For example, a healthcare service provider may transmit an identifier to a service provider via a network, and the service provider may transmit the necessary information to the healthcare service provider via the same network in response to receiving the identifier.

As discussed above, information embedded in the card may enable a relationship between a healthcare service provider and a subscriber, a healthcare service provider and a payer entity, or a healthcare service provider and a first party payment source, or a third party source, and so on, and may allow transfer of information between these parties. For example in some embodiments, information provided on the card may provide a healthcare service provider with basic information about the subscriber allowing the subscriber to initiate a relationship with the provider. 11 other embodiments, the entity which has issued the card may periodically update information embedded within the card and may provide provider with updated information about the subscriber. Updated information may be stored on the card and may be transmitted to a healthcare service provider and/or a financial service provider directly from the card or may be transmitted to the healthcare service provider and/or financial ser ice provider through a secondary source, such as, for example, a website or telephone number, following use of the card. In still other embodiments, information transmitted both directly from the card and through a secondary source.

In addition to information pertaining to the subscriber, the card may provide contact information for a payer entity, a first party payment source, a third party payment source, or a service provider, and may enable the healthcare service provider to contact any or all of these sources. For example, a healthcare service provider may contact a payer entity, a first party payment, or a third party payment source with an inquiry regarding identification of a subscriber or a subscriber's account with a payment source, verification of information on the card, verification of eligibility and benefits information, authorization. for a payment, issuance of payment and update of information about the subscriber and/or relationships between the subscriber and one or more financial service provider.

In embodiments of the invention, information embedded on a card may be accessed using a point-of-sale (POS) terminal, and this access may occur in phases. For example initially, an account may be set-up on a POS terminal or a computer processor attached the POS terminal for the subscriber using information embedded on the card. This information may be automatically updated when information embedded on the card is subsequently accessed. In other embodiments, a healthcare service provider may utilize information embedded within the card to predetermine what benefits may be obtained from each payment source for a specific service prior to rendering the service. The healthcare service provider may use this information to establish communication with each payment sources prior to rendering the service, perform the service, and bill each pavement source thereby expediting payment from each source, In certain embodiments, payment information from the card may be stored on the POS terminal or a computer processor attached to the POS terminal. The healthcare service provider may use the same information if additional services are required, or may re-access information embedded in the card to predetermine benefits that may be obtained from each source before performing the additional services, and may bill each respective predetermined source after rendering the additional services. In such embodiments, payment information may be stored by the service provider

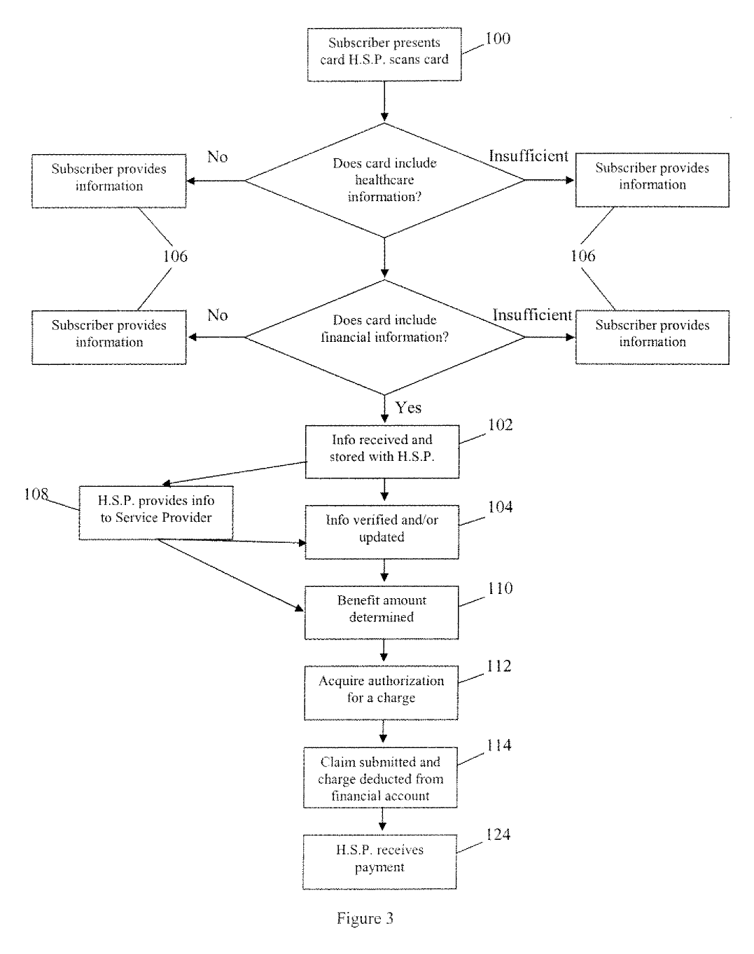

FIG. 3 illustrates a flowchart of an embodiment illustrating a method of using a card having a payer entity and a first party payment source information embedded on the card. In a first step 100 a subscriber may present the card to a healthcare service provider and the healthcare service provider may scan the card to retrieve relevant information. If the card does not contains healthcare information or does not contain sufficient health care data or financial or sufficient financial information, the subscriber may be asked to provide the relevant information, as in step 106. If the card contains healthcare and financial infuriation, the benefits information may be transmitted to a terminal or computer processor where it may be stored. as in step 102. The information provided on the card may then, optionally, be verified, as in step 104. In embodiments, verification may occur electronically, using, for example, an internet connection to the POS terminal or computer processor, or alternatively, verification may occur automatically when the card is scanned. In some embodiments, the healthcare service provider may use information embedded on the card to retrieve relevant healthcare benefit and eligibility information and/or financial information from, for example, a service provider, as in step 108. The healthcare service provider or service provider may determine the total benefit provided by the payer entity and the subscriber, as in step 110 and may, optionally, acquire authority to deduct an amount for which the subscriber is responsible from. the first party payment source as in step 112. The healthcare service provider or service provider may than submit claims and/or a charge may be deducted from the financial account associated with the card based on the determined benefit, as in step 114. A payment may than be transferred and received by the healthcare service provider from one or more payer entity and the financial account, as in step 124.

The above method may further include one or more processor or service providers who may mediate communication between various entities described, for example, a service provider may perform the verification as in step 104, and a separate service provider may deduct the charge from the financial account as in step 114.

Accordingly in some embodiments, a card having payer entity information and financial transaction information may eliminate complex distributed processing and retrieval of information between the multiple independent entities by providing all necessary information on the card, and providing this information at the point of sale location. The healthcare service provider may, therefore, perform all necessary calculations and processing in a single location. However in other embodiments, a payer entity, service provider, financial entity or combination of these may perform portions of, or all, at locations away from the point of sale without departing from the spirit and scope of the instant invention.

In other embodiments, information embedded in the card may permit all necessary information to complete a healthcare transaction, such as, for example, insurance policy information and subscriber's credit card information to be collected at a single location so that the determination of payment allocation can be made at that location. In other embodiments, information may be gathered from multiple sources, such as, an insurance company, credit card company, or service provider, and collected at a single location without co-mingling of information between the sources. In either case, processing may take place at a single location using all of the necessary information.

In embodiments, information may be transmitted by any method known in the art including, but not limited to, mail service, telephone lines, the world wide web, wireless network, DSL, cable modems, and the like. Embodiments of the invention may provide for security mechanisms that may ensure that the card holder is the subscriber. For example, cards of embodiments may include such features as PIN (personal identification number) codes, firewalls, special codes, infinite rolling codes, and combinations thereof and may be compliant with HIPAA regulations. Additionally transmission of data from the POS terminal may be secured by using, for example, a private network, encryption of data, point to point networks, and combinations thereof in various embodiments of the invention.

Another embodiment of the invention is directed to a system for facilitating payment using a magnetic swipe card. The system may include a magnetic swipe card, a means for scanning the magnetic swipe card, such as a POS terminal, a processor for receiving information from the magnetic swipe card, such as a computer, a means for utilizing the information from the magnetic swipe card to determine benefit eligibility and an amount for which an individual is responsible, a means for submitting a claim wherein information necessary for submitting the claim is provided on the magnetic swipe card, and a means for deducting the amount for which the individual is responsible from at least one first party payment source. In embodiments, information for deducting the amount for which the individual is responsible from at least one first party payment source may provided on the magnetic swipe card.

The processor, in embodiments, may provide the means for determining benefit eligibility and the amount for which the individual is responsible. The system may further include a means for transferring data between the processor and a payer entity to which the claim is submitted and the processor and the first party payment source, and in some embodiments, the means for transferring data may be the internet or a secured network. In certain embodiments, the steps of determining benefit eligibility, submitting the claim, and deducting the amount may occur automatically after the card has been swiped. In additional embodiments, the means for determining benefit eligibility, submitting the claim, and deducting the amount for which the individual is responsible may be a service provider.

Although the present invention has been described in the context of healthcare, it is understood that the merging of multiple forms of payment into a single payment vehicle can be applied to numerous applications outside the healthcare industry each of which are embodied herein.

In the foregoing description, certain terms have been used for brevity, clearness and understanding; but no unnecessary limitations are to be implied there from beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof. without departing from the spirit and scope of the invention. It is intended that all matter contained in the above description and shown in the accompanying drawings shall be interpreted as illustrative and not meant in a limiting sense.

The disclosure herein provides a number of advantages. For example, both financial and benefit and eligibility information may be obtained from a single card eliminating the need to carry separate cards for financial and healthcare, and the provider may obtain both financial and benefit information from a single swipe of a card of embodiments.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art, each of which are also intended to be encompassed by scope of this disclosure.

What is claimed is:

1. A magnetic swipe card for storing and transmitting data comprising a magnetic stripe having at least two tracks holding encoded data wherein a first track at least includes data for at least one first party payment source and a second track at least includes data for healthcare eligibility information for at least one card holder, said healthcare eligibility information further comprising at least one unique identifier or format code identifier, wherein the unique identifier or format code identifier is different from an identifier on the first track.

2. The magnetic swipe card of claim 1, wherein the at least one unique identifier is assigned by a service provider and wherein the unique identifier is a combination of characters unique to an individual holding the magnetic swipe card.

3. The magnetic swipe card of claim 1, wherein the at least one format code identifier is assigned by a service provider and wherein the format code identifier refers to a field in a database, table or reference sheet maintained by the service provider.

4. The magnetic swipe card of claim 1, wherein a unique identifier or format code identifier on the card, subscriber information on the card, patient information on the card, or a combination thereof provides a healthcare service provider with access to personal and benefit and eligibility information held by the service provider sufficient to launch a HIPAA compliant eligibility inquiry.

5. The magnetic swipe card of claim 1, wherein the at least first party payer entity is selected from a savings account, a checking account, a debit account, a credit card account, an electronic benefit transfer account, and a prepaid account.

6. The magnetic swipe card of claim 1, wherein the healthcare eligibility data on the second track comprises at least one unique identifier or format code identifier, personal data for at least one card holder, data for at least one payer entity, at least one third party payment source for the at least one card holder, and combinations thereof.

7. The magnetic swipe card of claim 1, wherein at least one payer entity is a healthcare payer entity or an insurance company.

8. The magnetic swipe card of claim 1, wherein the third party payment source is selected from government assistance, social security, cafeteria plan, gift certificate, loyalty credit, and insurance settlement account.

9. The magnetic swipe card of claim 1, wherein the first track at least comprises a field holding a first party payment account holder name or equivalent sub-fields and a field holding a first party payment account number or equivalent sub-fields.

10. The magnetic swipe card of claim n9, wherein at least the first track is ISO/IEC compliant.

11. The magnetic swipe card of claim 1, wherein the second track comprises fields selected from one or more subscriber ID, one or more subscriber ID qualifier, a subscriber date of birth, at least one payer entity ID, at least one payer entity qualifier, a subscriber name, a subscriber gender, a card format version number, a patient name, a patient relationship to a subscriber, a patient gender, at least one patient ID, at least one patient qualifier, and combinations thereof.

12. The magnetic swipe card of claim 1, wherein the card may be used for a financial transaction, healthcare benefit and eligibility transaction, or a combination thereof.

13. A method for initiating a financial transaction using a magnetic swipe card comprising:
providing a magnetic swipe card, said card comprising a magnetic stripe having at least two tracks holding encoded data wherein a first track at least includes data for at least one first party payment source and a second track at least includes data for healthcare eligibility information for at least one card holder, said healthcare eligibility information further comprising at least one unique identifier or format code identifier, wherein the at least one unique identifier or format code identifier is different from an identifier on the first track;
scanning the magnetic swipe card; and
performing at least one of a financial transaction, a healthcare benefit and eligibility transaction.

14. A method for initiating a financial transaction using a magnetic swipe card comprising:
providing a magnetic swipe card, said card comprising a magnetic stripe having at least two tracks holding encoded data wherein a first track at least includes data for at least one first party payment source and a second track at least includes data for healthcare eligibility information for at least one card holder, said healthcare eligibility information further comprising at least one unique identifier or format code identifier, wherein the at least one unique identifier or format code identifier is different from an identifier on the first track;
scanning the magnetic swipe card;
determining benefit eligibility for an individual from information provided on the card;
compiling benefit eligibility information, payment source information, and cost of services provided information;
estimating an amount for which the individual is responsible;
acquiring authorization from the individual to deduct the estimated amount from the at least one first party payment source;
submitting one or more claim to the at least one payer entity; and
deducting the amount for which the individual is responsible from the at least one first party payment source.

15. The method of claim 14, further comprising retrieving information selected from personal data for at least one card holder, eligibility and benefit data for the at least one card holder from at least one payer entity, at least one third party payment source for the at least one card holder, and combinations thereof from a service provider using the unique identifier or format code identifier on the card, subscriber information on the card, patient information on the card, or a combination thereof.

16. The method of claim 14, wherein the healthcare eligibility information for at least one card holder further comprises personal data for at least one card holder, data for at least one payer entity, data for one or more third party payment source, and combinations thereof.

17. The method of claim 14, wherein at least one of the steps of deducting or verifying eligibility information when the card is scanned occurs automatically.

18. The method of claim 14, wherein the step of acquiring authorization occurs automatically.

19. The method of claim 14, wherein the steps of determining benefit eligibility, estimating the amount for which an individual is responsible, submitting a claim, and deducting the amount for which the individual is responsible occur on a processor.

20. The method of claim 14, wherein the steps of determining benefit eligibility, estimating the amount for which an individual is responsible, submitting a claim, and deducting the amount for which the individual is responsible are completed by a service provider.

21. A system for facilitating payment using a magnetic swipe card comprising:
a magnetic swipe card comprising a magnetic stripe having at least two tracks holding encoded data wherein a first track at least includes data for at least one first party payment source and a second track at least includes data for healthcare eligibility information for at least one card holder, said healthcare eligibility information further comprising at least one unique identifier or format code identifier, wherein the unique identifier or format code identifier is different from an identifier on the first track;
a POS terminal. where the magnetic swipe card is scanned;
a processor for receiving information from the magnetic swipe card amid utilizing the information from the magnetic swipe card to determine benefit eligibility and an amount for which an individual is responsible;
a means for retrieving data for determining benefit eligibility information, personal information for at least one card holder, first party payment source information, third party payment source information, payer entity information, and combinations thereof;
a means for submitting a claim; and
a means for deducting the amount for which the individual is responsible from at least one first party payment source.

22. The system of claim 21 wherein the means for retrieving data, submitting the claim, and deducting the amount for which the individual is responsible is a service provider.
